(19) United States
(12) Patent Application Publication
(10) Pub. No.: US 2016/0116275 A1
(43) Pub. Date: Apr. 28, 2016

(54) GEOMETRIC-ERROR IDENTIFICATION SYSTEM AND GEOMETRIC-ERROR IDENTIFICATION METHOD

(71) Applicant: Okuma Corporation, Niwa-Gun (JP)

(72) Inventors: Tetsuya MATSUSHITA, Niwa-Gun (JP); Tadahiro OKI, Niwa-Gun (JP)

(21) Appl. No.: 14/850,022

(22) Filed: Sep. 10, 2015

(30) Foreign Application Priority Data
Oct. 27, 2014 (JP) 2014-218476

(51) Int. Cl. G01B 21/04

(52) U.S. Cl. CPC G01B 21/042

(57) ABSTRACT

A geometric-error identification system includes a control unit configured to identify geometric errors in a machine. The machine controls three or more translational axes and one or more rotation axes so as to perform positioning for a positional relationship between a main spindle and an object. The control unit controls the rotation axis so as to index a measurement object jig, measures an indexed position of the indexed measurement object jig on a three-dimensional space using a position measurement sensor attached to the main spindle so as to acquire a measurement value, and identifies geometric errors of the machine related to the translational axis and/or the rotation axis based on the measurement values in a plurality of positions. The control unit measures an initial position of the measurement object jig and performs calibration of the position measurement sensor using an initial measurement value acquired for measuring the initial position.

### BACKGROUND

This application claims the benefit of Japanese Patent Application Number 2014-218476 filed on Oct. 27, 2014 the entirety of which is incorporated by reference.

### TECHNICAL FIELD

The present invention relates to a geometric-error identification system and a geometric-error identification method for identifying a geometric error in a machine that includes a translational drive axis and a rotational drive axis.

### RELATED ART

Conventionally, there is a multi-axis machine tool as a machine that includes a translational drive axis and a rotational drive axis. For example, the multi-axis machine tool disclosed in Japanese Patent Application Publication No. 2011-38902 (JP-A-2011-38902) controls the operations in the five axial directions in total, which include the C-axis and the A-axis as the rotation axes on a table side in addition to the X-axis, the Y-axis, and the Z-axis as the orthogonal three axes, to perform processing. In this multi-axis machine tool, geometric errors between the respective axes, for example, the error of the center position in the rotation axis and the tilt error (the perpendicularity and the parallelism between the axes) of the rotation axis are factors affecting the motion accuracy. For example, in the multi-axis machine tool disclosed in JP-A-2011-38902, there are 13 geometric errors in total including three geometric errors of the perpendicularity between the X and Y axes, the perpendicularity between the Y and Z axes, and the perpendicularity between the Z and X axes as geometric errors related to the translational axes, two geometric errors of the perpendicularity between the tool and the Y-axis and the perpendicularity between the tool and the X-axis as geometric errors related to a main spindle, and eight geometric errors of the X-direction error of the C-axis center position, the offset error between the C and A axes, the angular offset error of the A-axis, the perpendicularity between the C and A axes, the Y-direction error of the A-axis center position, the Z-direction error of the A-axis center position, the perpendicularity between the A and Z axes, and the perpendicularity between the A and Y axes as geometric errors related to the rotation axes on the table side. Accordingly, in that multi-axis machine tool, to improve the processing accuracy, it is necessary to identify these geometric errors for compensation.

Methods for identifying the above-described geometric errors include, for example, the method disclosed in JP-A-2011-38902. This method uses a touch trigger probe, which is attached to the main spindle as a position measurement sensor, and a target ball, which is a jig as a measurement object. The method measures the center position of the target ball in the state where a distal end of the touch trigger probe is in contact with the surface of the target ball while indexing the table, to which the target ball is fixed, at a plurality of rotation angles and tilt angles, so as to identify the geometric errors from the obtained measurement result.

To perform measurement with the touch trigger probe as described above, calibration is necessary. This is because the main spindle center as the reference of the position of the feed axis is offset with respect to the position of the feed axis when the distal end of the touch trigger probe is in contact with the surface of the target ball by the radius of the distal end (the stylus ball) of the touch trigger probe. The offset is also caused by misalignment between the main spindle center and the touch trigger probe, signal delay during contact into the target ball, the sensor characteristics of the touch trigger probe, and similar cause. Then, these offset amounts differ depending on the contact direction with the target ball.

Therefore, as a calibration method of the touch trigger probe, the methods described in Japanese Patent Application Publication Nos. 4-63664 and 58-82649 are conventionally known. The method described in JP-A-4-63664 includes mounting a dial gauge on a main spindle, disposing the center of the ring gauge as the reference and the main spindle center in a concentric manner, and then mounting a touch trigger probe on the main spindle to have contact with the inner diameter of the ring gauge, so as to obtain a radial-direction compensation value of the touch trigger probe based on the skip value and the inner diameter value of the ring gauge at this time. On the other hand, the method described in JP-A-58-82649 using a processing object having a bore as the reference causes a touch trigger probe to be in contact with the bore inner diameter in one direction and rotates the main spindle by 180 degrees when the touch trigger probe is contacted in the opposite direction. Then, the average value of both the skip values is used to obtain a bore center position and obtain the compensation values in the respective directions.

Obviously, the touch trigger probe needs to be calibrated before the measurement for identifying the geometric errors. Heat generation of the main spindle causes thermal displacement, a secular change, and similar result so as to change the compensation value of the touch trigger probe. Accordingly, the calibration is preferred to be performed immediately before the measurement. However, in the methods described in JP-A-4-63664 and JP-A-58-82649 described above, it is necessary to prepare another measuring instrument such as a dial gauge, or separately prepare the reference such as a ring gauge and a processing object having bores. Accordingly, there has been a problem where the calibration is very burdensome. Additionally, once the calibration is performed, the subsequent calibration is not often performed. There has also been a problem where the accuracy of the identification of the geometric errors is low and the positioning accuracy of the machine eventually becomes low (for example, the machine tool cannot perform machining with high accuracy).

Therefore, the present invention has been made in view of the above-described problems, and it is an object of the present invention to provide a geometric-error identification system and a geometric-error identification method for facilitating the calibration of the position measurement sensor so as to facilitate improvement in positioning accuracy in the machine.

### SUMMARY

To achieve the above-described object, a first aspect of the invention is a geometric-error identification system that includes a control unit configured to identify geometric errors in a machine. The machine includes a main spindle. The machine is configured to control three or more translational axes and one or more rotation axes other than the main spindle so as to perform positioning for a positional relationship between the main spindle and an object. The control unit is configured to control the rotation axis so as to index a measurement object jig in a plurality of positions, measure an indexed position of the indexed measurement object jig on a three-dimensional space using a position measurement sensor attached to the main spindle so as to acquire a measurement value, and identify geometric errors of the machine related to the translational axis and/or the rotation axis based on the measurement values in the plurality of positions. The control unit is configured to measure an initial position of the measurement object jig and perform calibration of the position measurement sensor using an initial measurement value acquired for measuring the initial position.

A second aspect of the invention is as follows. In the invention according to the first aspect, the position measurement sensor is a touch trigger probe, and the measurement object jig is a ball jig.

To achieve the above-described object, a third aspect of the invention is a geometric-error identification method for identifying geometric errors in a machine. The machine includes a main spindle. The machine is configured to control three or more translational axes and one or more rotation axes other than the main spindle so as to perform positioning for a positional relationship between the main spindle and an object. The method includes controlling the rotation axis so as to index a ball jig in a plurality of positions, measuring an indexed position of the indexed ball jig on a three-dimensional space using a touch trigger probe attached to the main spindle so as to acquire a measurement value, and identifying geometric errors of the machine related to the translational axis and/or the rotation axis based on the measurement values in the plurality of positions. The method executes a first step of indexing the main spindle in four or more directions and bringing an identical point of the touch trigger probe into contact with the ball jig in an initial position so as to perform measurement, a second step of obtaining a center position on a predetermined plane of the ball jig based on a measurement value measured in the first step, a third step of indexing the main spindle in one direction and bringing the touch trigger probe into contact with the ball jig in the initial position at five or more points so as to perform measurement, a fourth step of obtaining a center position in a direction perpendicular to the plane of the ball jig, obtaining a center position of the ball jig on a three-dimensional space in the initial position, and obtaining a compensation value in a radial direction of the touch trigger probe, based on measurement values measured in the first step and the third step, and a fifth step of measuring the ball jig indexed in the plurality of positions using the compensation value so as to identify the geometric errors.

The present invention allows performing calibration of the position measurement sensor such as a touch trigger probe using the initial measurement value acquired to measure the initial position of the measurement object jig, so as to perform calibration of the position measurement sensor simultaneously with measurement of the initial position. Accordingly, it is not necessary to prepare another measuring instrument such as a dial gauge, and it is possible to facilitate calibration. The calibration is performed each time the initial position of the measurement object jig is measured. This allows improving the accuracy for identifying geometric errors, so as to improve the positioning accuracy in the machine.

### BRIEF DESCRIPTION OF DRAWINGS

FIG. 1 is a perspective explanatory view illustrating a multi-axis machine tool.

FIG. 2 is an explanatory view illustrating a state where a target ball is installed on a table.

FIG. 3 is a flowchart illustrating a control related to identification of geometric errors.

FIG. 4 is a flowchart illustrating a control related to measurement of the initial position and calibration of a touch trigger probe.

FIG. 5 is an explanatory view illustrating the relationship between a measurement value and the ball center in the measurement of the initial position of the target ball with the touch trigger probe.

FIG. 6 is an explanatory view illustrating the relationship between a measurement value and a compensation value of the touch trigger probe in the measurement of the initial position of the target ball with the touch trigger probe.

### DETAILED DESCRIPTION

The following describes geometric-error identification system and method as one embodiment of the present invention in detail based on the drawings. Here, in this embodiment, a description will be given of identification of geometric errors in a five-axis control machining center as one example of a machine that includes a translational axis and a rotation axis.

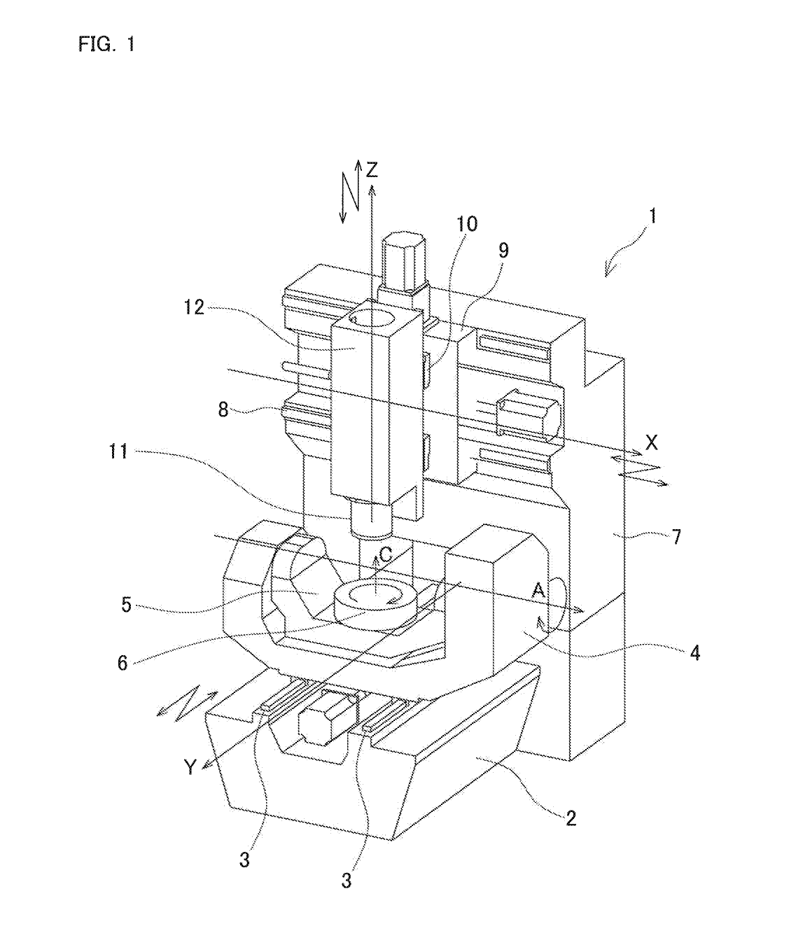

Firstly, a description will be given of a multi-axis machine tool 1 based on FIG. 1. FIG. 1 is a perspective explanatory view illustrating the multi-axis machine tool 1. Here, the X-axis, the Y-axis, and the Z-axis in FIG. 1 are orthogonal three axes (the translational axes provided in the multi-axis machine tool 1). Assuming that the Y-axis direction is the front-back direction in the multi-axis machine tool 1, the X-axis direction is the right-left direction, and the Z-axis direction is the above-below direction.

On the top surface of a bed 2 of the multi-axis machine tool 1, Y-axis guides 3 and 3 are formed, and an AC axis unit 4 in the trunnion structure is installed on these Y-axis guides 3 and 3 movably in the Y-axis direction. The AC axis unit 4 includes a cradle 5 formed having a U shape that is wide in the right-left direction in front view. This cradle 5 can be turned and tilted around the A-axis (the rotation axis) parallel to the X-axis direction by an A-axis drive mechanism (not shown) incorporated in the right and left portions. The AC axis unit 4 includes a table 6 for holding a workpiece as a processing target on the top surface of the cradle 5. This table 6 is rotatable by 360 degrees around the C-axis (the rotation axis) parallel to the Z-axis by a C-axis drive mechanism (not shown) incorporated in the cradle 5.

A cross rail 7 in a gate-shaped structure is secured to the bed 2 while striding across the Y-axis guides 3 and 3. On the front face of the cross rail 7, an X-axis guide unit 8 is formed. Then, on the X-axis guide unit 8, a lamb saddle 9 is installed movably in the X-axis direction. The lamb saddle 9 includes a Z-axis guide unit 10. On the Z-axis guide unit 10, a main spindle head 12 including a main spindle 11 at a lower end thereof is installed movably in the Z-axis direction. Here, the lamb saddle 9, the AC axis unit 4, and the main spindle head 12 can be moved by a ball screw installed parallel to the guide surfaces of the respective guide units and a servo motor coupled to this ball screw. The multi-axis machine tool 1 includes an NC unit (control unit) (not shown) including a geometric-error identification apparatus, and the NC unit controls the driving of the respective members such as the AC axis unit 4 and the main spindle head 12 in the respective axial directions.

The above-described multi-axis machine tool 1 turns and rotates the workpiece secured onto the table 6 around the A-axis and around the C-axis and also moves the workpiece in the Y-axis direction. On the other hand, the multi-axis machine tool 1 moves the main spindle 11 mounted with a tool in the X-axis direction and the Z-axis direction, so as to perform multi-surface processing on the workpiece.

Here, a description will be given of a method for identifying geometric errors in the multi-axis machine tool 1 as the main part of the present invention.

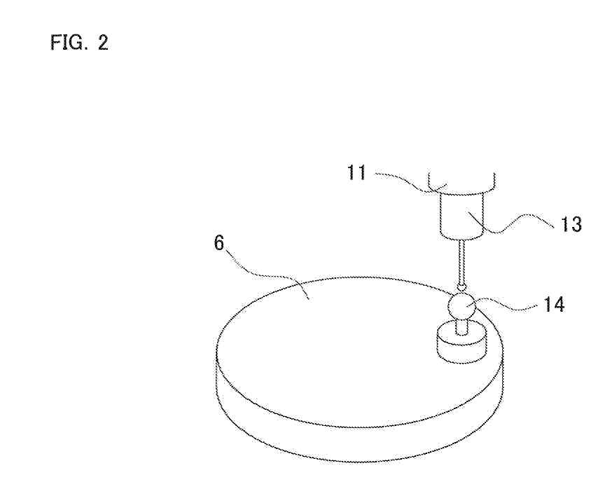

To identify geometric errors in the multi-axis machine tool 1, a touch trigger probe 13 is attached to the main spindle 11 before the measurement while a target ball 14 is installed in a predetermined position on the table 6 (in FIG. 2). The main spindle head 12 is positioned such that the distal end of the touch trigger probe 13 is positioned in the vicinity of the apex in the +Z direction of the target ball 14. Furthermore, the diameter of the target ball 14 is preliminarily measured by a coordinate measuring machine or similar machine, and then a touch-trigger-probe axial-direction compensation value t1 is acquired by a known method (for example, a method for obtaining a tool-length compensation value of an ordinary tool).

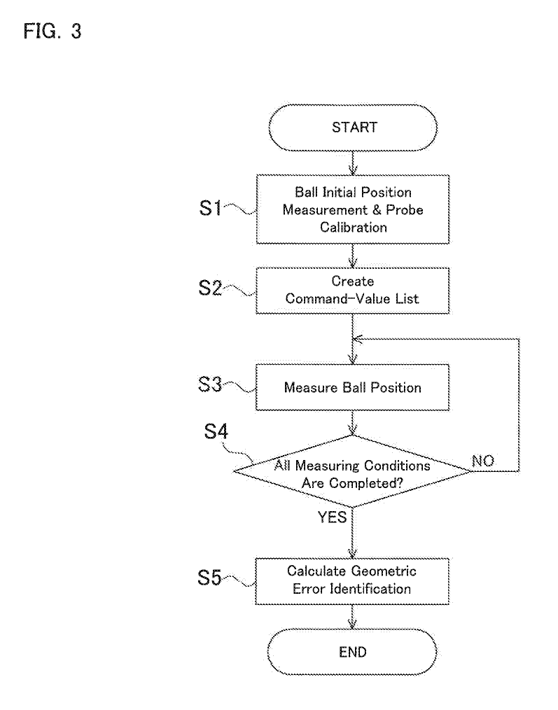

A description will be given of the method for identifying the geometric errors according to a flowchart illustrated in FIG. 3. As described below, the center position (the center initial value) of the target ball 14 is measured, and the target ball 14 is used to calibrate the touch trigger probe 13 (in S1). Subsequently, the touch-trigger-probe axial-direction compensation value t1 and the center initial value measured in S1 are used to calculate the center position (a center expected value) of the target ball 14 and the distal end position of the touch trigger probe 13, which are expected after movement when the rotation axis is rotated under the preliminarily set measuring condition (including the indexing angles of the respective rotation axes) (in S2). Furthermore, the center expected values (that is, to be three-dimensional-position coordinate values) calculated at the respective indexing angles are set to the command values (the command values of the translational axes) of the X-axis, the Y-axis, and the Z-axis, and a command-value list where the respective indexing angles are set to the command values of the rotation axes is created (in S2).

The respective axes are controlled based on the command-value list created in S2 to index the target ball 14 in the predetermined position, and the touch trigger probe 13 is brought into contact with indexed four points (or more points) on the surface of the target ball 14 to perform measurement, so as to calculate the center position (a center measurement value) and the diameter value (a diameter measurement value) of the target ball 14 (in S3). Here, the already-known diameter value (the diameter value measured with the coordinate measuring machine or similar machine before S1) of the target ball 14 can be used to obtain the center measurement value and similar value even by a measurement in contact with three points on the surface of the target ball 14.

Furthermore, in the case where it is determined whether the measurement on all the indexed positions is completed (in S4) and the measurement is not completed (in the case where NO is determined in S4), the next measurement is performed (in S3). In the case where the measurement is completed (in the case where YES is determined in S4), the geometric errors of the multi-axis machine tool 1 are identified and calculated based on the calculated center measurement value and the command values of the command list (in S5), so as to identify the geometric errors in the multi-axis machine tool 1.

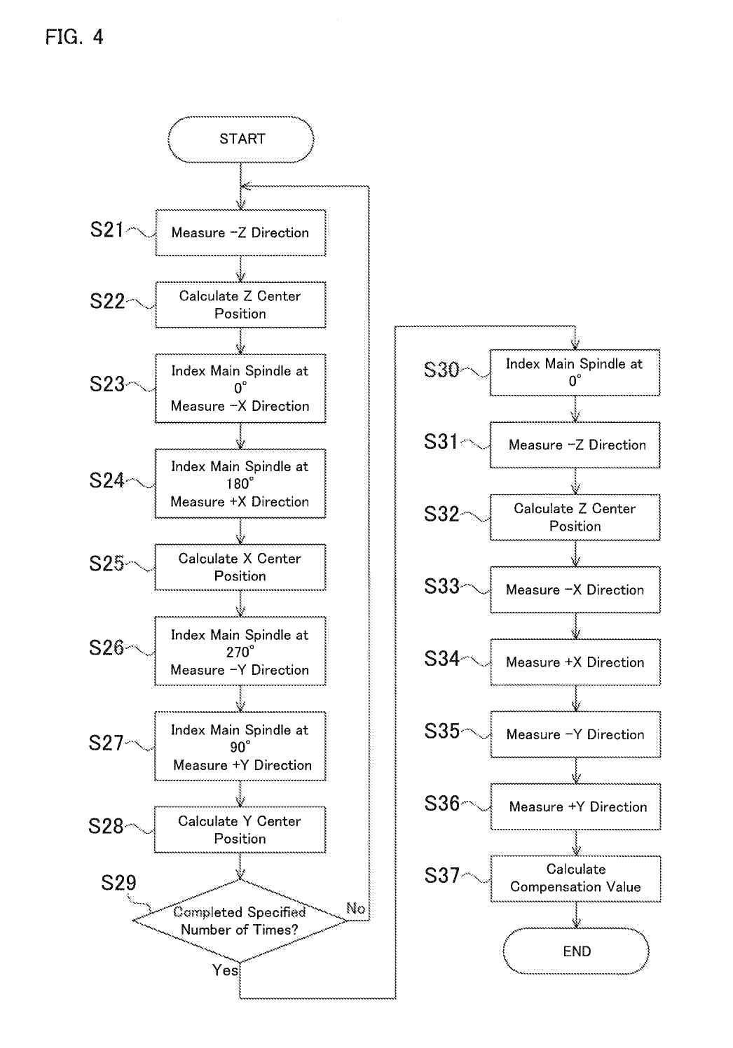

Here, a detailed description will be given of the measurement of the center initial value and the calibration of the touch trigger probe 13 in S1 according to a flowchart illustrated in FIG. 4. Here, to bring the touch trigger probe 13 into contact with the target ball 14, the touch trigger probe 13 is intentionally brought into contact with the apices in the respective directions, but it is difficult to have strict contact with the apex. Accordingly, the “apex” includes not only a strict apex, but also the vicinity of the apex.

To measure the center initial value and perform calibration of the touch trigger probe 13, firstly, the touch trigger probe 13 is moved in the −Z direction to be in contact with the apex in the +Z direction of the target ball 14 and a measured Z-axis coordinate value zm1 is stored (in S21). A known diameter value d0 of the target ball 14 and the touch-trigger-probe axial-direction compensation value t1, which is preliminarily acquired, are used to obtain an assumed Z center position zt based on Formula 1 below (in S22).

zt=zm1−d0/2−t1 [Formula 1]

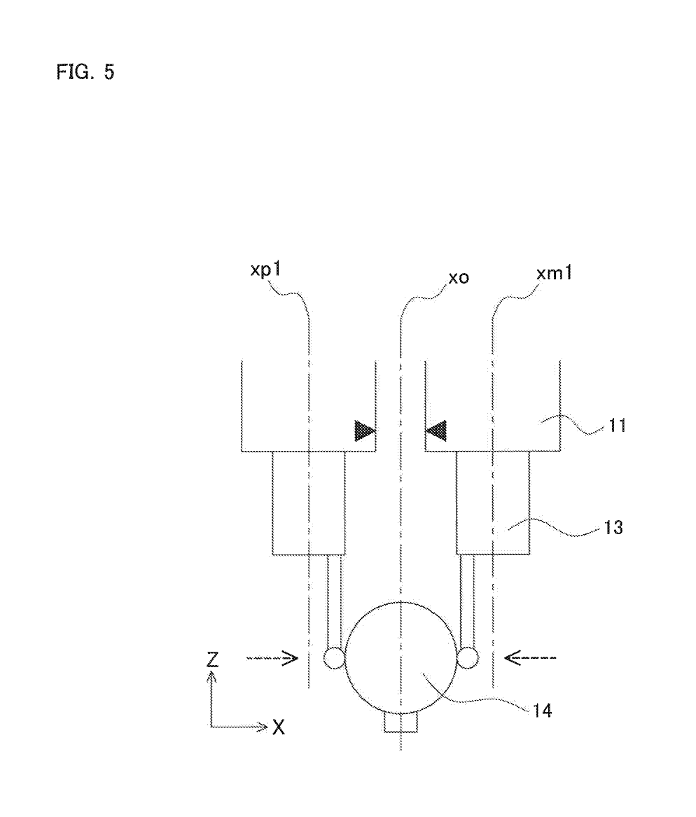

Subsequently, the main spindle 11 is indexed at 0°, and the main spindle head 12 is positioned such that the distal end of the touch trigger probe 13 is positioned in the vicinity of the apex in the +X direction of the target ball 14. Subsequently, the touch trigger probe 13 is moved in the −X direction to be in contact with the apex in the +X direction of the target ball 14 and a measured X-axis coordinate value xml is stored (in S23). The main spindle 11 is indexed at 180° such that the point identical to the point contacted in S23 is brought into contact with the target ball 14, and the main spindle head 12 is positioned such that the distal end of the touch trigger probe 13 is positioned in the vicinity of the apex in the −X direction of the target ball 14. Subsequently, the touch trigger probe 13 is moved in the +X direction so as to be in contact with the apex in the −X direction of the target ball 14, and a measured X-axis coordinate value xp1 is stored (in S24). Then, the stored X-axis coordinate value xp1 and X-axis coordinate value xm1 are used to obtain an X center position xo based on Formula 2 below (in S25). As just described, the point identical to the distal end of the touch trigger probe 13 is brought into contact with the target ball 14 (illustrated in FIG. 5) so as to allow obtaining the X center position xo without being affected by the difference of the characteristics due to the difference of the contact direction of the touch trigger probe 13, swinging of the touch trigger probe 13 and the main spindle 11, and similar cause.

xo=(xp1+xm1)/2 [Formula 2]

Furthermore, the main spindle 11 is indexed at 270°, and the main spindle head 12 is positioned such that the distal end of the touch trigger probe 13 is positioned in the vicinity of the apex in the +Y direction of the target ball 14. Subsequently, the touch trigger probe 13 is moved in the −Y direction so as to be in contact with the apex in the +Y direction of the target ball 14, and a measured Y-axis coordinate value ym1 is stored (in S26). The main spindle 11 is indexed at 90° such that the point identical to the point contacted in S26 is brought into contact with the target ball 14, and the main spindle head 12 is positioned such that the distal end of the touch trigger probe 13 is positioned in the vicinity of the apex in the −Y direction of the target ball 14. Subsequently, the touch trigger probe 13 is moved in the +Y direction so as to be in contact with the apex in the −Y direction of the target ball 14, and a measured Y-axis coordinate value yp1 is stored (in S27). Then, the stored Y-axis coordinate value yp1 and Y-axis coordinate value ym1 are used to obtain a Y center position yo based on Formula 3 below (in S28).

yo=(yp1+ym1)/2 [Formula 3]

Then, it is determined whether the calculation of the assumed Z center position zt, the X center position xo, and the Y center position yo is performed as many times as a preliminarily set specified number of times (in S29). When the calculation is not performed as many times as the specified number of times (NO is determined in S29), the process returns to S21 so as to calculate the assumed Z center position zt, the X center position xo, and the Y center position yo again. Subsequently, the calculation of the assumed Z center position zt, the X center position xo, and the Y center position yo is repeated in S21 to S29 up to the specified number of times. When the number of the calculations reaches the specified number of times (YES is determined in S29), the process proceeds to S30.

Then, in S30, the main spindle 11 is indexed at 0°, which is the angle indexed during ordinary measurement. Subsequently, the main spindle head 12 is positioned such that the distal end of the touch trigger probe 13 is positioned at the X coordinate xo, the Y coordinate yo, and an Z coordinate that is the position in the vicinity of the apex in the +Z direction of the target ball 14. Subsequently, the touch trigger probe 13 is moved in the −Z direction to be in contact with the apex in the +Z direction of the target ball 14, and a measured Z-axis coordinate value zm2 is stored (in S31). Then, in addition to the stored Z-axis coordinate value zm2, the known diameter value d0 of the target ball 14 and the touch-trigger-probe axial-direction compensation value t1, which is preliminarily acquired, are used to obtain a Z center position zo based on Formula 4 below (in S32).

zo=zm2−d0/2−t1 [Formula 4]

The main spindle bead 12 is positioned such that the distal end of the touch trigger probe 13 is positioned at an X coordinate that is the position in the vicinity of the apex in the +X direction of the target ball 14, the Y coordinate yo, and the Z coordinate zo. Subsequently, the touch trigger probe 13 is moved in the −X direction to be in contact with the apex in the +X direction of the target ball 14, and a measured X-axis coordinate value xm2 is stored (in S33). The main spindle head 12 is positioned such that the distal end of the touch trigger probe 13 is positioned at an X coordinate that is the position in the vicinity of the apex in the −X direction of the target ball 14, the Y coordinate yo, and the Z coordinate zo. Subsequently, the touch trigger probe 13 is moved in the +X direction to be in contact with the apex in the −X direction of the target ball 14, and a measured X-axis coordinate value xp2 is stored (in S34).

Furthermore, the main spindle head 12 is positioned such that the distal end of the touch trigger probe 13 is positioned at the X coordinate xo, an Y coordinate that is the position in the vicinity of the apex in the +Y direction of the target ball 14, and the Z coordinate zo. Subsequently, the touch trigger probe 13 is moved in the −Y direction to be in contact with the apex in the +Y direction of the target ball 14, and a measured Y-axis coordinate value ym2 is stored (in S35). The main spindle head 12 is positioned such that the distal end of the touch trigger probe 13 is positioned at the X coordinate xo, a Y coordinate that is positioned in the vicinity of the apex in the −Y direction of the target ball 14, and the Z coordinate zo. Subsequently, the touch trigger probe 13 is moved in the +Y direction to be in contact with the apex in the −Y direction of the target ball 14, and a measured Y-axis coordinate value yp2 is stored (in S36).

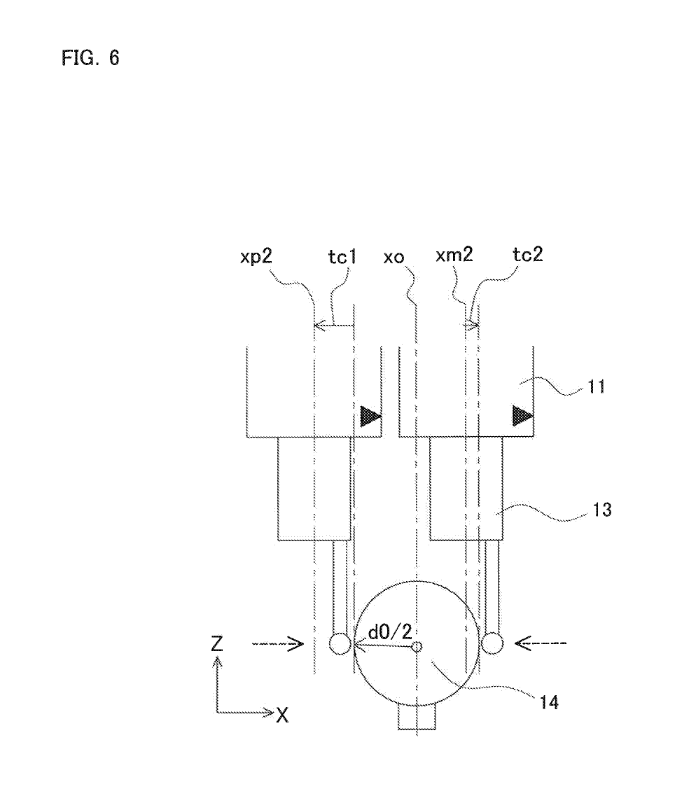

Subsequently, a touch-trigger-probe radial-direction compensation value tc1 in the +X direction, a touch-trigger-probe radial-direction compensation value tc2 in the −X direction, a touch-trigger-probe radial-direction compensation value tc3 in the +Y direction, and a touch-trigger-probe radial-direction compensation value tc4 (that is, calibrated values) in the −Y direction are obtained based on Formula 5 below (in S37). That is, the center of the main spindle 11 coincides with the center of the target ball 14. As illustrated in FIG. 6, this allows obtaining respective touch-trigger-probe radial-direction compensation values from the respective coordinate values acquired at this time, the center positions xo and yo of the target ball 14, and the diameter value d0 of the target ball 14.

tc1=xo−xp2−d0/2

tc2=xo−xm2+d0/2

tc3=yo−yp2−d0/2

tc4=yo−ym2+d0/2 [Formula 5]

As just described, in S1, the measurement of the center initial values (the X center position xo, the Y center position yo, and the Z center position zo) and the calibration (acquisition of the touch-trigger-probe radial-direction compensation values) of the touch trigger probe 13 are performed.

Here, assume that the measurement values of the respective axes to have contact with the point on the surface of the ball toward the center of the target ball 14 are (xs, ys, zs). The touch-trigger-probe radial-direction compensation values (tax, tay, taz) can be obtained based on Formula 6 below.

tax=xo−xs−d0/2

tay=yo−ys+d0/2

taz=zo−zs+d0/2 [Formula 6]

The following describes the identification of the geometric errors in S5 in detail.

Assume that, under one measuring condition, one side of the rotation axis is fixed and the other side is indexed at a plurality of angles to measure the center position of the target ball 14. The difference vector of the measurement value in the center position with respect to the command value under this measuring condition can be decomposed into three components of the radial direction, the axial direction, and the tangential direction of the indexing axis. These respective components can be approximated by a least-squares method as an arc having errors such as Fourier series of a zero-order component (a radius error), a first-order component (a center deviation), and a second-order component (an elliptical shape). A radial direction component dRrᵢ, an axial direction component dRaᵢ, and a tangential direction component dRtᵢ of the measurement value in the k-th indexing angle θᵢⱼₖ of the j-th rotation axis under a measuring condition i can be expressed as Formula 7 below.

dRrᵢ=ra0ᵢ+ra1ᵢ*cos(θᵢⱼₖ)+rb1ᵢ*cos(θᵢⱼₖ)+ra2ᵢ cos(2θᵢⱼₖ)+rb2ᵢ sin(2θᵢⱼₖ)

dRaᵢ=aa0ᵢ+aa1ᵢ*cos(θᵢⱼₖ)+ab1ᵢ*cos(θᵢⱼₖ)+aa2ᵢ cos(2θᵢⱼₖ)+ab2ᵢ sin(2θᵢⱼₖ)

dRtᵢ=ta0ᵢ+ta1ᵢ*cos(θᵢⱼₖ)+tb1ᵢ*cos(θᵢⱼₖ)+ta2ᵢ cos(2θᵢⱼₖ)+tb2ᵢ sin(2θᵢⱼₖ) [Formula 7]

Here, in a geometric error existing in the multi-axis machine tool 1, assume that the perpendicularity between the X and Y axes is dCxy, the perpendicularity between the Y and Z axes is dAxz, the perpendicularity between the Z and X axes is dBxz, the X-direction error of the C-axis center position is dXca, the offset error between the C and A axes is dYca, the angular offset error of the A-axis is dAca, the perpendicularity between the C and A axes is dBca, the Y-direction error of the A-axis center position is dYay, the Z-direction error of the A-axis center position is dZay, the perpendicularity between the A and Z axes is dBay, and the perpendicularity between the A and Y axes is dCay.

Assume that the measuring condition 1 is set to 0° in the A-axis and 0° to 360° in the C-axis, the measuring condition 2 is set to −90° in the C-axis and −90° to +90° in the A-axis, and the measuring condition 3 is set to −90° in the A-axis and 0° to 180° in the C-axis. Then, the relationship between the respective coefficients in Formula 7 and the respective geometric errors is Formula 8 below. Accordingly, Formula 8 is deformed so as to allow calculating, that is, identifying the respective geometric errors. Here, R₁, R₂, and R₃ are distances from the rotational center to the center position of the target ball 14 on the plane on which all the ball center positions by the commands are placed under the respective measuring conditions 1, 2, and 3, that is, the radii of the arc trajectory.

ra1₁=−dXca−(dBca+dBay+dBxz)*H

rb1ᵢ=dYca+dYay−(daca+dAxz)*H

rb2₁=dCyx*R₁/2

aa1₁=dBca+dBay

ab1₁=dAca

ra1₂=−dYay

rb1₂=dZay

rb2₂=−dAxz*R₂/2

aa1₂=dCay

ab1₂=−(dBay+dBxz)

rb2₃=dBxz*R₃/2 [Formula 8]

The geometric-error identification system and method having the configuration as described above perform calibration in the radial direction on the distal end portion of the touch trigger probe 13 using the measurement values for measuring the center initial value (the initial position) of the target ball 14, so as to allow performing calibration of the touch trigger probe 13 simultaneously with measurement of the center initial value. Subsequently, the center position of the target ball 14 is measured while the table 6 to which the target ball 14 is secured is rotated and tilted, and the geometric errors of the multi-axis machine tool 1 are identified based on the acquired measurement values. Accordingly, it is not necessary to prepare another measuring instrument such as a dial gauge, and it is possible to facilitate calibration. The calibration is performed each time the initial position of the target ball 14 is measured. This allows improving the accuracy for identifying geometric errors, so as to improve the positioning accuracy (the processing accuracy in the multi-axis machine tool 1) in the multi-axis machine tool 1.

Here, the geometric-error identification system and method according to the present invention are not limited to the form of the above-described embodiment, and can be changed as necessary without departing from the spirit of the present invention.

For example, the machine targeted by the geometric-error identification system and method according to the present invention is not limited to the multi-axis machine tool in the above-described embodiment, and may be a machine tool other than the machining center, for example, a lathe, a combined processing machine, and a grinder. The machine may be a machine tool having only four axes insofar as a machine has at least three translational axes and one rotation axis, or may be a machine tool having six or more axes. Furthermore, the machine tool may include two or more rotation axes on the main spindle side, may include one rotation axis for each of the main spindle side and the table side, or may include only one rotation axis in one of the main spindle side and the table side alone. Additionally, the machine tool is not necessary, but an industrial machine or a robot may be used.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

What is claimed is:

1. A geometric-error identification system comprising
a control unit configured to identify geometric errors in a machine, the machine including a main spindle, the machine being configured to control three or more translational axes and one or more rotation axes other than the main spindle so as to perform positioning for a positional relationship between the main spindle and an object, the control unit being configured to: control the rotation axis so as to index a measurement object jig in a plurality of positions; measure an indexed position of the indexed measurement object jig on a three-dimensional space using a position measurement sensor attached to the main spindle so as to acquire a measurement value; and identify geometric errors of the machine related to at least one of the translational axis and the rotation axis based on the measurement values in the plurality of positions, wherein
the control unit is configured to measure an initial position of the measurement object jig and perform calibration of the position measurement sensor using an initial measurement value acquired for measuring the initial position.

2. The geometric-error identification system according to claim 1, wherein
the position measurement sensor is a touch trigger probe, and the measurement object jig is a ball jig.

3. A geometric-error identification method for identifying geometric errors in a machine, wherein
the machine includes a main spindle, the machine being configured to control three or more translational axes and one or more rotation axes other than the main spindle so as to perform positioning for a positional relationship between the main spindle and an object,
the method comprises:
controlling the rotation axis so as to index a ball jig in a plurality of positions;
measuring an indexed position of the indexed ball jig on a three-dimensional space using a touch trigger probe attached to the main spindle so as to acquire a measurement value; and
identifying geometric errors of the machine related to at least one of the translational axis and the rotation axis based on the measurement values in the plurality of positions,
a first step of indexing the main spindle in four or more directions and bringing an identical point of the touch trigger probe into contact with the ball jig in an initial position so as to perform measurement;
a second step of obtaining a center position on a predetermined plane of the ball jig based on a measurement value measured in the first step;
a third step of indexing the main spindle in one direction and bringing the touch trigger probe into contact with the ball jig in the initial position at five or more points so as to perform measurement;
a fourth step of obtaining a center position in a direction perpendicular to the plane of the ball jig, obtaining a center position of the ball jig on a three-dimensional space in the initial position, and obtaining a compensation value in a radial direction of the touch trigger probe, based on measurement values measured in the first step and the third step; and
a fifth step of measuring the ball jig indexed in the plurality of positions using the compensation value so as to identify the geometric errors.
